(19) United States
(12) Patent Application Publication
(10) Pub. No.: US 2018/0243753 A1
(43) Pub. Date: Aug. 30, 2018

(54) MOBILE GRINDING FACILITY

(71) Applicant: Imerys Mineral Limited, Par Cornwall (GB)

(72) Inventors: Ron UNDERWOOD, Singapore (SG); Leong Woon TEO, Waterloo (BE); Bernhard WEBER, Munchen (DE); Richard TAMBLYN, London Greater London (GB); Desmond Charles PAYTON, St Austell Cornwall (GB); Anthony NOON, New Taipei City (TW)

(21) Appl. No.: 15/760,687

(22) PCT Filed: Sep. 16, 2016
(86) PCT No.: PCT/EP2016/071950

§ 371 Date: Mar. 16, 2018

(30) Foreign Application Priority Data
Sep. 18, 2015 (SG) 10201507790R

(51) Int. Cl. B02C 21/02; B02C 23/02; B02C 23/08

(52) U.S. Cl. CPC B02C 21/02; B02C 23/08; B02C 23/02

(57) ABSTRACT

A mobile facility, and relates methods, for producing an inorganic particulate material comprising: one or more grinders; a feeder for providing feed material to the one or more grinders; and auxiliary apparatus; wherein the facility is configured or adapted to produce an inorganic particulate material whereby the particle size of the feed material is reduced by a ratio of at least about 10:1, or about 100:1, or about 1,000:1 to produce the inorganic particulate material.

### TECHNICAL FIELD

The present invention is directed to a mobile facility for producing an inorganic particulate material, to a mobile facility for grinding a fibrous substrate comprising cellulose, and to related methods of producing an inorganic particulate material and ground fibrous substrate comprising cellulose.

### BACKGROUND OF THE INVENTION

As the identification of mineral deposits in new and remote locations increases, there is a need for processing facilities which can be put to use on such deposits quickly, efficiently and in an environmentally less intrusive manner, particularly where the quality and quantity of the mineral deposit is difficult to quantify and/or the mineral deposit is situated in an environmentally sensitive location.

### SUMMARY OF THE INVENTION

According to a first aspect, there is provide a mobile facility for producing an inorganic particulate material comprising:
one or more grinders;
a feeder for providing feed material to the one or more grinders; and
auxiliary apparatus;
   wherein the facility is configured or adapted to produce an inorganic particulate material whereby the particle size of the feed material is reduced by a ratio of at least about 10:1, or about 100:1, or about 1,000:1 to produce the inorganic particulate material.

According to a second aspect, there is provided a method of relocating a mobile facility for producing an inorganic particulate material, the method comprising:
at a first location, removing (e.g., dismantling) a previously installed mobile facility according to the first or seventh aspect,
transporting the dismantled mobile facility to a second location, and
installing the mobile facility at the second location.

According to a third aspect, there is provided a method of installing a mobile facility for producing an inorganic particulate material, the method comprising:
transporting a mobile facility according to the first or seventh aspect to a location, and
installing the mobile facility at the location.

According to a fourth aspect, there is provided a method of manufacturing an inorganic particulate material, the method comprising grinding a feed material in a mobile facility according to the first aspect to produce an inorganic particulate material, whereby the particle size of the feed material is reduced by a ratio of at least about 10:1.

According to a fifth aspect, there is provided a mobile facility for grinding a fibrous substrate comprising cellulose comprising:
one or more grinders;
a feeder for providing feed material to the one or more grinders; and
   wherein the facility is configured or adapted to grind a fibrous substrate comprising cellulose.

According to a sixth aspect, there is provided a method of grinding a fibrous substrate comprising cellulose, optionally in the absence of an inorganic particulate material, the method comprising grinding a feed material comprising a fibrous substrate comprising cellulose in a mobile facility according to the fifth aspect, optionally wherein the feed material is ground to produce microfibrillated cellulose.

According to a seventh aspect, there is provided a mobile facility for producing an inorganic particulate material comprising:
one or more reactors in a modular container for making an inorganic particulate material, for example, precipitated calcium carbonate;
optionally one or more grinders for grinding starting material fed to the one or more reactors and/or for grinding the inorganic material produced in the one or more reactors;
a feeder for providing starting material to the one or more reactors and/or the optional one or more grinders; and auxiliary apparatus.

According to an eighth aspect, there is provided a method of manufacturing an inorganic particulate material, the method comprising making an inorganic particulate material, for example, precipitated calcium carbonate, in a mobile facility according to the seventh aspect.

### DETAILED DESCRIPTION OF THE DESCRIPTION

By “mobile” it is meant that the facility is able to move or be moved easily in a relatively short time frame and transportable between locations, and installable non-permanently enabling de-installation, relocation, re-installation and reuse. By “non-permanently” is meant that the facility can be disassembled and ready for relocation to another site in no more than about a month or so (e.g., in less than about 50 days, or less than about 40 days, or less than about calendar month, or less than about 4 weeks, or less than about 3 weeks, or less than about 2 weeks, or less than about 1 week).

In certain embodiments, the facility is modular. By “modular” it is meant that the facility is composed of self-contained units or sections for easy construction or flexible arrangement. The self-contained units or sections may be of a standardized size and form. The self-contained units can be combined or interchanged with others like it to construct or modify the mobile facility. The modular arrangement also facilitates transportation between different (remote) locations, for example, between a manufacturing site or sites at which modules are manufactured and a production site at which the mobile is installed to produce the inorganic particulate material, or between different production sites. The modular system can be characterized by functional partitioning into discrete scalable, transportable, reusable and replaceable modules.

The mobile and modular facility offers many benefits including reduction in cost, flexibility in design, augmentation (e.g., retro-fit and expansion/addition of further modules) and exclusion (including replacement or repair), quick installation, quick deployment and quick removal and relocation. Environmental benefits include reduced energy consumption, reduced carbon foot-print including reduced CO₂ emissions. For instance, the non-permanent installation reduces the need or even eliminates the need for foundations (e.g., the mobile facility may in certain embodiments may be foundationless). This means that the amount of foundation materials such as concrete and the like required to install the facility may be significantly reduce compared to installation of a larger, permanent facility.

The various modules may be containerized, for example, in a plurality of intermodal freight containers. The intermodal container can be used across different modes of transport from ship to rail to truck. Intermodal containers exist in many types and a number of standardized sizes. Commonly, the containers are either of 20 foot or 40 foot (6 or 12 m) standard length. The common heights are 8 feet 6 inches (2.6 m) and 9 feet 6 inches (2.9 m), the latter being known as ‘High Cube’ (HC) containers. In certain embodiments, one or more of the containers may be open-top and/or open-side, enabling ready access to the apparatus contained therein.

Dimensions of common standardized types of container are given below in Table 1.

In certain embodiments, the mobile facility comprises a plurality of intermodal units, e.g., containers (e.g., stackable and/or modular containers) which are housed in or on a vehicular conveying means, for example, a truck and the like, for example, the flat-bed of a flat-bed truck. In such embodiments, the mobile facility may be configured to produce the inorganic particulate material in one or more reactors, in accordance with the seventh and/or eight aspects. In such embodiments, the mobile facility may be configured to produce the inorganic particulate material in accordance with the first and/or fourth aspects.

In certain embodiments, the mobile facility comprises a plurality of 20 and/or 40 foot containers, each container comprising one or more parts of the mobile facility for producing inorganic particulate material. The contents of the each module or container may differ according to function. For example, one or more modules/containers, or modular containers, may comprise apparatus designed for delivery and initial preparation of the feed/starting material prior to grinding and/or reaction, another optionally modular container may comprise the one of more grinders and/or one or more reactors, another may comprise post-grind classification apparatus, and another may comprise storage apparatus. Other modules/containers may contain support structures and/or pumping and/or piping. Yet further modules/containers may operate as an office or control room, for example, an electrical and power control room.

In addition to the one or more grinders and/or one or more reactors and feeder, the mobile facility includes auxiliary apparatus suitable for the production of the inorganic particulate material from the coarse feed material. The auxiliary apparatus may comprises a variety of pre-grinding apparatus such as for example, feed hoppers and crushers or other coarse sizing means as well as conveying means for transporting the feed material from the hopper to the sizing means (e.g., a bucket elevator) and to the feeder and then into the one or more grinders. The mobile facility may additionally comprise support structures for the one or more grinders and/or one or more reactors (and other auxiliary apparatus), which may additionally comprise pumps and piping and space to drain, if necessary, media from the one or more grinders. Post-grinding, the facility may comprise a classification system, which may include classifiers, sizers and/or separators. Post-reaction, the facility may comprise a classification system, which may include classifiers, sizers and/or separators. For example, the mobile facility may comprise one or more screens, such as vibrating screens, and a centrifuge system. The centrifuge may be configured discharge to a storage tank. The mobile facility may comprise further equipment such as fresh- and white-water tanks, a dispersant feed tank and biocide feed tank. In certain embodiments, the mobile facility per se does not comprise such tanks, but is configured to be connected thereto upon installation at the site of production.

In certain embodiments, the auxiliary apparatus comprises one or more of: front-end loader, feed hopper(s), surge hopper(s), bucket elevator(s), crusher(s), support structure(s) for the one or more grinders, support structure(s) for the one or more reactors, pump(s), drainage equipment, screen(s), classifier(s), chute(s), storage tank(s), white water tank(s) and feed system, fresh water tank(s) and feed system, dispersant tank(s) and feed system, biocide tank(s) and feed system, control room and office, and electrical and power control room.

TABLE 1

| | | | | | | 40′ high- | | 45′ high- | |
|---|---|---|---|---|---|---|---|---|---|
| | | 20′ container | | 40′ container | | cube container | | cube container | |
| | | Imperial | Metric | Imperial | Metric | Imperial | Metric | Imperial | Metric |
| External dimensions | Length | 9′ 10.5″ | 6.058 m | 40′ 0″ | 12.192 m | 40′ 0″ | 12.192 m | 45′ 0″ | 13.716 m |
| | Width | 8′ 0″ | 2.438 m | 8′ 0″ | 2.438 m | 8′ 0″ | 2.438 m | 8′ 0″ | 2.438 m |
| | Height | 8′ 6″ | 2.591 m | 8′ 6″ | 2.591 m | 9′ 6″ | 2.896 m | 9′ 6″ | 2.896 m |
| Internal dimensions | Length | 19′ 3″ | 5.867 m | 39′ 5 45/64″ | 12.032 m | 39′ 4″ | 12.000 m | 44′ 4″ | 13.556 m |
| | Width | 7′ 8 19/32″ | 2.352 m | 7′ 8 19/32″ | 2.352 m | 7′ 7″ | 2.311 m | 7′ 8 19/32″ | 2.352 m |
| | Height | 7′ 8⅛″ | 2.343 m | 7′ 8⅛″ | 2.343 m | 7′ 6″ | 2.280 m | 7′ 8⅛″ | 2.343 m |

| | | | | | | | | |
|---|---|---|---|---|---|---|---|---|
| Internal volume | 1,169 ft³ | 33.1 m³ | 2,385 ft³ | 67.5 m³ | 2,660 ft³ | 75.3 m³ | 3,040 ft³ | 86.1 m³ |

In certain embodiments, the mobile facility comprises at least:
a feed hopper in a first module/container;
a bucket elevator in a second module/container;
a surge hopper, crusher and the feeder for feed material in a third module/container;
the one or more grinders in a fourth module/container;
support structure for the one or more grinders in a fifth module/container; one or more vibrating screens in a sixth module/container;
a centrifuge feed tank in a seventh module/container;
a centrifuge in an eighth module/container; and
a storage tank for the inorganic particulate material in a ninth module/container.

The mobility and modularity of the mobile facility enables, at short notice, ready installation and de-installation, and relocation of the mobile facility to a location where a need arises. Thus, in one aspect there is provided a method for relocating a mobile facility for producing an inorganic particulate material, the method comprising:
at a first location, removing (e.g., dismantling) a previously installed mobile facility according to certain embodiments described herein,
transporting the dismantled mobile facility to a second location, and installing the mobile facility at the second location.

In certain embodiments, removing the previously installed mobile facility ready for transportation is conducted in a period of no more than about a calendar month, for example, no more than about 4 weeks, or no more than about 3 weeks, or no more than about 2 weeks, or no more than about 1 week.

The first location may be at least about 100 km from the second location, for example, at least about 500 km, or at least about 1000 km, or at least about 1500 km, or at least about 2000 km, or at least about 2500 km from the second location. Relocation may comprise transport by rail, road and/or sea. In certain embodiments, relocation comprises transport by air.

In certain embodiments, the mobile facility which is to be dismantled for relocation is non-permanently installed at the first location.

In certain embodiments, for example, embodiments in which the mobile facility is housed in or on a vehicular conveying means, the mobile facility may be configured for permanent mobility. That is, it is intended to be moved from site to site on demand and as desired without being permanently installed at a site.

The location or site of installation has civil, water and electrical power supplies in situ. The mobile facility is suitable for producing an inorganic particulate material which is considerably finer than the feed material from which it is produced. The facility is therefore configured or adapted to produce an inorganic particulate material whereby the particle size of the feed material is reduced by a ratio of at least about 10:1. Thus, by way of example, if the feed material has a particle size of about 1 mm and the inorganic particulate material produced therefrom has a particle size of about 100 μm, then the particle size of the feed material is reduced by a ratio of about 10:1. By way of another example, if the feed material has a particle size of about 2 mm and the inorganic particulate material produced therefrom has a particle size of about 2 μm, then the particle size of the feed material is reduced by a ratio of about 1000:1. By way of another example, if the feed material has a particle size of about 25 mm and the inorganic particle produced therefrom has a particle size of about 1 μm, then the particle size of the feed material is reduced by a ratio of about 25,000:1

The particle size of the feed material and inorganic particulate material may be determined according to conventional methods known in the art which are suitable for measuring the relatively coarse (i.e., the feed material) and fine (i.e., the inorganic particulate material) materials used and produced in accordance with the present invention.

For example, for the relatively coarse feed material, particle size may be determined by screening or sieving. Thus, in certain embodiments, the particle size of the feed material is determined or obtained by screening or sieving using an appropriately sized screen or sieve. In such embodiments, the particle size refers to the aperture size of the screen or sieve, e.g., a feed material having a particle size of 5 mm is a feed material which passes through a screen or sieve having 5 mm apertures.

For the relatively finer inorganic particulate material, particles size may determined as the mean particle size, d₅₀, which is the value of the particle e.s.d (equivalent spherical diameter) at which there are 50% by weight of the particles which have an e.s.d less than that d₅₀ value. In certain embodiments, the particle size, d₅₀, of the inorganic particulate is measured in a well known manner by sedimentation of the particulate material in a fully dispersed condition in an aqueous medium using a Sedigraph 5100 machine as supplied by Micromeritics Instruments Corporation, Norcross, Ga., USA (web-site: www.micromeritics.com), referred to herein as a “Micromeritics Sedigraph 5100 unit”. Such a machine provides measurements and a plot of the cumulative percentage by weight of particles having a size, referred to in the art as the e.s.d, less than given e.s.d values.

In certain embodiments, to produce the inorganic particulate material the particle size of the feed material is reduced by a ratio of at least about 50:1, or at least about 100:1, or at least about 250:1, or at least about 500:1, or at least about 750:1, or at least about 1000:1, or at least about 1250:1, or at least about 1500:1, or at least about 2000:1, or at least about 3000:1, or at least about 4000:1, or at least about 5000:1, or at least about 6000:1, or at least about 7000:1, or at least about 8000:1, or at least about 9000:1, or at least about 10,000:1, or at least about 12,500:1, or at least about 15:000:1, or at least about 17,500:1, or at least about 22,500:1, or at least about 25;000:1. In certain embodiments, the particle size of the feed material is reduced by a ratio of no more than about 100,000:1, for example, no more than about 50,000:1. In such embodiments, the particle size of the feed material is at least about 0.5 mm, or at least about 1 mm, or at least about 1.5 mm, or at least about 2 mm, or at least about 2.5 mm, or at least about 3 mm, or at least about 3.5 mm, or at least about 4 mm, or at least about 4.5 mm, or at least about 5 mm. In certain embodiments, the particle size of the feed material is at least about 10 mm, or at least about 25 mm, or at least about 50 mm, or at least about 100 mm, or at least about 150 mm, or at least about 200 mm.

In certain embodiments, the particle size of the feed material is no greater than about 200 mm, for example, no greater than about 150 mm, or no greater than about 100 mm, or no greater than about 50 mm, or no greater than about 10 mm, or no greater than about 8 mm, or no greater than about 6 mm.

In certain embodiments, the particle size of the feed material fed to the first of the one or more grinders is at least about 0.5 mm, or at least about 1 mm, or at least about 1.5 mm, or at least about 2 mm, or at least about 2.5 mm, or at least about 3 mm, or at least about 3.5 mm, or at least about 4 mm, or at least about 4.5 mm, or at least about 5 mm, or at least about 10 mm, or at least about 15 mm, or at least about 20 mm, or at least about 25 mm.

In certain embodiments, the particle size, d₅₀, of the inorganic particulate material which is produced from the feed material is no greater than about 250 μm, for example, no greater than about 100 μm, or no greater than about 50 μm, or no greater than about 25 μm, or no greater than about 10 μm, or no greater than about 5 μm, or no greater than about 2 μm, or no greater than about 1.5 μm, or no greater than about 1 μm. In certain embodiments, the particle size, d₅₀, of the inorganic particulate material is at least about 0.1 μm, or at least about 0.25 μm, or at least about 0.5 μm.

In certain embodiments, the particle size of the feed material is at least about 1 mm and the particle size of the inorganic particulate material is no greater than about 5 μm, for example, no greater than about 2 μm.

In certain embodiments, the particle size of the feed material is at least about 2 mm and the particle size of the inorganic particulate material is no greater than about 5 μm, for example, no greater than about 2 μm.

In certain embodiments, the particle size of the feed material is at least about 5 mm and the particle size of the inorganic particulate material is no greater than about 5 μm, for example, no greater than about 2 μm.

In certain embodiments, the particle size of the feed material is at least about 20 mm and the particle size of the inorganic particulate material is no greater than about 2 μm, for example, the particle size of the feed material is at least about 25 mm and the particle size of the inorganic particulate material is no greater than about 1 μm.

A described above, the facility, including the one or more grinders, is configured or adapted to produce inorganic particulate material having the desired particle size, d₅₀, from a feed material having a particle size of at least about 0.5 mm, or at or at least about 1 mm, or at least about 1.5 mm, or at least about 2 mm, or at least about 2.5 mm, or at least about 3 mm, or at least about 3.5 mm, or at least about 4 mm, or at least about 4.5 mm, or at least about 5 mm.

The inorganic particulate material (and, thus, the feed material) may, for example, be an alkaline earth metal carbonate or sulphate, such as calcium carbonate, magnesium carbonate, dolomite, gypsum, a hydrous kandite clay such as kaolin, halloysite or ball clay, an anhydrous (calcined) kandite clay such as metakaolin or fully calcined kaolin, talc, mica, perlite or diatomaceous earth, or magnesium hydroxide, or aluminium trihydrate, or combinations thereof.

In certain embodiments, the inorganic particulate material is calcium carbonate. Hereafter, the invention may tend to be discussed in terms of calcium carbonate, and in relation to aspects where the calcium carbonate is processed and/or treated. The invention should not be construed as being limited to such embodiments.

The particulate calcium carbonate used in the present invention may be obtained from a natural source by grinding. Ground calcium carbonate (GCC) is typically obtained by crushing and then grinding a mineral source such as chalk, marble or limestone. The feed material may be ground autogenously, i.e. by attrition between the particles of the feed material themselves, or, alternatively, in the presence of a particulate grinding medium comprising particles of a different material from the calcium carbonate to be ground. These processes may be carried out with or without the presence of a dispersant and biocides, which may be added at any stage of the process.

In certain embodiments, the feed material additionally comprises a fibrous substrate comprising cellulose and, thus, the mobile facility including, for example, the one or more grinders, is configured or adapted to grind a fibrous substrate comprising cellulose. In certain embodiments, a fibrous substrate is added separately to at least one of the one more grinders.

The fibrous substrate comprising cellulose may be in the form of a pulp (i.e., a suspension of cellulose fibres in water), which may be prepared by any suitable chemical or mechanical treatment, or combination thereof. For example, the pulp may be a chemical pulp, or a chemithermomechanical pulp, or a mechanical pulp, or a recycled pulp, or a papermill broke, or a papermill waste stream, or waste from a papermill, or a combination thereof. The cellulose pulp may be beaten (for example in a Valley beater) and/or otherwise refined (for example, processing in a conical or plate refiner) to any predetermined freeness, reported in the art as Canadian standard freeness (CSF) in cm³. CSF means a value for the freeness or drainage rate of pulp measured by the rate that a suspension of pulp may be drained. For example, the cellulose pulp may have a Canadian standard freeness of about 10 cm³ or greater prior to being microfibrillated. The cellulose pulp may have a CSF of about 700 cm³ or less, for example, equal to or less than about 650 cm³, or equal to or less than about 600 cm³, or equal to or less than about 550 cm³, or equal to or less than about 500 cm³, or equal to or less than about 450 cm³, or equal to or less than about 400 cm³, or equal to or less than about 350 cm³, or equal to or less than about 300 cm³, or equal to or less than about 250 cm³, or equal to or less than about 200 cm³, or equal to or less than about 150 cm³, or equal to or less than about 100 cm³, or equal to or less than about 50 cm³. The cellulose pulp may then be dewatered by methods well known in the art, for example, the pulp may be filtered through a screen in order to obtain a wet sheet comprising at least about 10% solids, for example at least about 15% solids, or at least about 20% solids, or at least about 30% solids, or at least about 40% solids. The pulp may be utilised in an unrefined state, that is to say, without being beaten or dewatered, or otherwise refined.

The fibrous substrate comprising cellulose may be added to the one or more grinders in a dry state. For example, a dry paper broke may be added directly to the one or more grinders. In certain embodiments, the aqueous environment in the grinder will facilitate the formation of a pulp.

In certain embodiments, the fibrous substrate comprising cellulose is ground to produce smaller fibrils. In certain embodiments, the fibrous substrate comprising cellulose is microfibrillated during grinding, producing microfibrillated cellulose. By microfibrillated is meant a process in which microfibrils of cellulose are liberated or partially liberated as individual species or as smaller aggregates as compared to the fibres of the pre-microfibrillated pulp. Typical cellulose fibres (i.e., pre-microfribrillated pulp) include larger aggregates of hundreds or thousands of individual cellulose microfibrils.

The fibrous substrate comprising cellulose may be microfibrillated in the presence of the inorganic particulate material to obtain microfibrillated cellulose having a d₅₀ ranging from about 5 to μm about 500 μm, as measured by laser light scattering. The fibrous substrate comprising cellulose may be microfibrillated in the presence of the inorganic particulate material to obtain microfibrillated cellulose having a d₅₀ of equal to or less than about 400 μm, for example equal to or less than about 300 μm, or equal to or less than about 200 μm, or equal to or less than about 150 μm, or equal to or less than about 125 μm, or equal to or less than about 100 μm, or equal to or less than about 90 μm, or equal to or less than about 80 μm, or equal to or less than about 70 μm, or equal to or less than about 60 μm, or equal to or less than about 50 μm, or equal to or less than about 40 μm, or equal to or less than about 30 μm, or equal to or less than about 20 μm, or equal to or less than about 10 μm.

The fibrous substrate comprising cellulose may be microfibrillated in the presence of an inorganic particulate material to obtain microfibrillated cellulose having a modal fibre particle size ranging from about 0.1-500 μm and a modal inorganic particulate material particle size ranging from 0.25-20 μm. The fibrous substrate comprising cellulose may be microfibrillated in the presence of an inorganic particulate material to obtain microfibrillated cellulose having a modal fibre particle size of at least about 0.5 μm, for example at least about 10 μm, or at least about 50 μm, or at least about 100 μm, or at least about 150 μm, or at least about 200 μm, or at least about 300 μm, or at least about 400 μm.

The fibrous substrate comprising cellulose may be microfibrillated in the presence of an inorganic particulate material to obtain microfibrillated cellulose having a fibre steepness equal to or greater than about 10, as measured by Malvern. Fibre steepness (i.e., the steepness of the particle size distribution of the fibres) is determined by the following formula:

Steepness=100×(d₃₀/d₇₀)

The microfibrillated cellulose may have a fibre steepness equal to or less than about 100. The microfibrillated cellulose may have a fibre steepness equal to or less than about 75, or equal to or less than about 50, or equal to or less than about 40, or equal to or less than about 30. The microfibrillated cellulose may have a fibre steepness from about 20 to about 50, or from about 25 to about 40, or from about 25 to about 35, or from about 30 to about 40.

Unless otherwise stated, particle size properties of the microfibrillated cellulose materials are as are as measured by the well known conventional method employed in the art of laser light scattering, using a Malvern Mastersizer S machine as supplied by Malvern Instruments Ltd (or by other methods which give essentially the same result).

Details of the procedure used to characterise the particle size distributions of mixtures of inorganic particle material and microfibrillated cellulose using a Malvern Mastersizer S machine are provided in WO2010/131016.

In certain embodiments, at least one of the one or more grinders is a wet grinder (i.e., the grinding process is a wet-grinding process). In certain embodiments, all of the grinders are wet-grinders.

In certain embodiments, at least one of the one or more grinders is an autogenous grinder (i.e., the grinding process is an autogenous grinding process). In certain embodiments, all of the grinders are autogenous grinders. In certain embodiments, the autogenous grinder(s) is a tumbling mill.

In certain embodiments, at least one of the one or more grinders is a semi-autogenous grinder (i.e., the grinding process is a semi-autogenous grinding process). In certain embodiments, all of the grinders are semi-autogenous grinders.

In certain embodiments, the mobile facility does not comprise a ball mill.

In certain embodiments, the mobile facility comprises a mill/grinder other than a ball mill.

In certain embodiments, the mobile facility comprises a mill/grinder selected from a tumbling mill, bead mill, disk mill, edge mill, hammer mill, lsa mill, jet mill, planetary mill, stirred mill, vibratory mill, vertical shaft impactor mill, rod mill, autogenous mill, SAG mill, pebble mill, sand mill and tower mill, and any combination thereof.

Wet grinding of calcium carbonate (and optional fibrous substrate comprising cellulose) involves the formation of an aqueous suspension of the calcium carbonate which may then be ground, optionally in the presence of a suitable dispersing agent. Reference may be made to, for example, EP-A-614948 (the contents of which are incorporated by reference in their entirety) for more information regarding the wet grinding of calcium carbonate.

The grinding is suitably performed in a conventional manner. The grinding may be an attrition grinding process in the presence of a particulate grinding medium, or may be an autogenous grinding process, i.e., one in the absence of a grinding medium. By grinding medium is meant a medium other than feed material.

The particulate grinding medium, when present, may be of a natural or a synthetic material. The grinding medium may, for example, comprise balls, beads or pellets of any hard mineral, ceramic or metallic material. Such materials may include, for example, alumina, zirconia, zirconium silicate, aluminium silicate or the mullite-rich material which is produced by calcining kaolinitic clay at a temperature in the range of from about 1300° C. to about 1800° C. For example, in some embodiments a ceramic grinding media is used. In certain embodiments, an at least 90% pure alumina grinding media is used. Alternatively, particles of natural sand of a suitable particle size may be used.

Generally, the type of and particle size of grinding medium to be selected for use in the invention may be dependent on the properties, such as, e.g., the particle size of, and the chemical composition of, the feed suspension of material to be ground. Preferably, the particulate grinding medium comprises particles having an average diameter in the range of from about 0.1 mm to about 6.0 mm and, more preferably, in the range of from about 0.2 mm to about 4.0 mm. The grinding medium (or media) may be present in an amount up to about 70% by volume of the charge. The grinding media may be present in amount of at least about 10% by volume of the charge, for example, at least about 20% by volume of the charge, or at least about 30% by volume of the charge, or at least about 40% by volume of the charge, or at least about 50% by volume of the charge, or at least about 60% by volume of the charge.

In certain embodiments, the facility and related methods are configured or adapted for wet-grinding. Wet-grinding advantageously consumes lower power per tonne of product, has higher capacity for per until grinder volume, enables the use of wet screening and/or classification for close control of product particle size, eliminates dust, and generally simplifies handling and transport aspects such as pumps and pipes.

The grinding may be carried out in one or more stages. In certain embodiments, the facility comprises only one grinder. In certain embodiments, the facility comprises a plurality of grinders, for example, two grinders, or more than two grinders, for example, three grinders, or four grinders, or five grinders. The plurality of grinders may be operatively linked in series or parallel or a combination of series and parallel. The output from and/or the input to one or more of the grinders in the facility may be subjected to one or more screening steps and/or one or more classification steps.

The total energy expended in a grinding process may be apportioned equally across each of the grinders in the facility. Alternatively, the energy input may vary between some or all of the grinders in the facility.

In an embodiment the grinding is performed in a closed circuit. In another embodiment, the grinding is performed in an open circuit. The grinding may be performed in batch mode, for example, a re-circulating batch mode, or in continuous mode.

The grinding circuit may include a pre-grinding step or steps in which a coarse feed material is ground in a first grinder to a predetermined particle size distribution, after which it passed to a different grinder until the desired particle size has been obtained.

A suitable dispersing agent may be added to the suspension prior to grinding or added sequentially during grinding or after grinding and dewatering. The dispersing agent may be, for example, a water soluble condensed phosphate, polysilicic acid or a salt thereof, or a polyelectrolyte, for example a water soluble salt of a poly(acrylic acid) or of a poly(methacrylic acid) having a number average molecular weight not greater than 80,000. The amount of the dispersing agent used would generally be in the range of from 0.1 to 2.0% by weight, based on the weight of the dry feed material. The suspension may suitably be ground at a temperature in the range of from 4° C. to 100° C.

The pH of the suspension of material to be ground may be about 7 or greater than about 7 (i.e., basic), for example, the pH of the suspension may be about 8, or about 9, or about 10, or about 11. The pH of the suspension of material to be ground may be less than about 7 (i.e., acidic), for example, the pH of the suspension may be about 6, or about 5, or about 4, or about 3. The pH of the suspension of material to be ground may be adjusted by addition of an appropriate amount of acid or base. Suitable bases included alkali metal hydroxides, such as, for example NaOH. Other suitable bases are sodium carbonate and ammonia. Suitable acids included inorganic acids, such as hydrochloric and sulphuric acid, or organic acids. An exemplary acid is orthophosphoric acid.

In some circumstances, minor additions of other minerals may be included, for example, one or more of kaolin, calcined kaolin, wollastonite, bauxite, talc or mica, could also be present.

When the feed material is obtained from naturally occurring sources, it may be that some mineral impurities will contaminate the ground material. For example, naturally occurring calcium carbonate can be present in association with other minerals. Thus, in some embodiments, the feed material and, thus, the inorganic particulate material, includes an amount of impurities. In general, however, the feed material used and inorganic particulate produced will contain less than about 5% by weight, preferably less than about 1% by weight, of other mineral impurities.

In certain embodiments, the feed material may be treated to reduce or remove impurities, e.g., by flocculation, flotation, reductive bleaching or magnetic separation techniques well known in the art. The auxiliary apparatus may include apparatus suitable for flocculation, flotation, reductive bleaching or magnetic separation of the feed material.

In alternative embodiments, there is provided a modular facility for producing an inorganic particulate material comprising:
one or more reactors;
a feeder for providing reactants to the one or more reactors; and
auxiliary apparatus;
wherein the facility is configured or adapted to produce an inorganic particulate material whereby the particle size of less than no greater than about 250 μm. For example, the particle size is no greater than about 100 μm, or no greater than about 50 μm, or no greater than about 25 μm, or no greater than about 10 μm, or no greater than about 5 μm, or no greater than about 2 μm, or no greater than about 1.5 μm, or no greater than about 1 μm. In certain embodiments, the particle size, d₅₀, of the inorganic particulate material is at least about 0.1 μm, or at least about 0.25 μm, or at least about 0.5 μm.

The inorganic particulate produced by the modular facility may be precipitated calcium carbonate (PCC). The PCC may be produced by any of the known methods available in the art. TAPPI Monograph Series No 30, “Paper Coating Pigments”, pages 34-35, the contents of which are incorporated herein by reference, describes the three main commercial processes for preparing precipitated calcium carbonate which is suitable for use in preparing products for use in the paper industry, but may also be used in connection with the embodiments of the present invention. In all three processes, limestone is first calcined to produce quicklime, and the quicklime is then slaked in water to yield calcium hydroxide or milk of lime. In the first process, the milk of lime is directly carbonated with carbon dioxide gas. This process has the advantage that no by-product is formed, and it is relatively easy to control the properties and purity of the calcium carbonate product. In the second process, the milk of lime is contacted with soda ash to produce, by double decomposition, a precipitate of calcium carbonate and a solution of sodium hydroxide. The sodium hydroxide should be substantially completely separated from the calcium carbonate if this process is to be commercially attractive. In the third main commercial process, the milk of lime is first contacted with ammonium chloride to give a calcium chloride solution and ammonia gas. The calcium chloride solution is then contacted with soda ash to produce, by double decomposition, precipitated calcium carbonate and a solution of sodium chloride. Alternatively, PCC may be made by reacting gypsum (calcium sulphate) with ammonium carbonate or ammonium bicarbonate. Alternatively, PCC may be made by reacting calcium chloride with sodium carbonate or ammonium carbonate. In certain embodiments, therefore, the mobile facility is configured to produce wet or dry PCC by any one or more of the methods described herein, and appropriate feeder and auxiliary apparatus selected depending on the requirements of the process by which the PPC to be produced.

The process for making PCC results in very pure calcium carbonate crystals and water. The crystals can be produced in a variety of different shapes and sizes, depending on the specific reaction process that is used. The three main forms of PCC crystals are aragonite, rhombohedral and scalenohedral, all of which are suitable for use in embodiments of the present invention, including mixtures thereof.

In a further alternative embodiment, there is provided a mobile facility for grinding a fibrous substrate comprising cellulose comprising:
one or more grinders;
a feeder for providing feed material to the one or more grinders; and
auxiliary apparatus.

In certain embodiments, the mobile facility is configured or adapted to produce microfibrillated cellulose. The grinding may be conducted in the presence of a grinding medium, and carried out in the absence of an inorganic particulate material.

The fibrous substrate comprising cellulose may be microfibrillated to obtain microfibrillated cellulose having a d₅₀ ranging from about 5 to μm about 500 μm, as measured by laser light scattering. The fibrous substrate comprising cellulose may be microfibrillated to obtain microfibrillated cellulose having a d₅₀ of equal to or less than about 400 μm, for example equal to or less than about 300 μm, or equal to or less than about 200 μm, or equal to or less than about 150 μm, or equal to or less than about 125 μm, or equal to or less than about 100 μm, or equal to or less than about 90 μm, or equal to or less than about 80 μm, or equal to or less than about 70 μm, or equal to or less than about 60 μm, or equal to or less than about 50 μm, or equal to or less than about 40 μm, or equal to or less than about 30 μm, or equal to or less than about 20 μm, or equal to or less than about 10 μm.

The fibrous substrate comprising cellulose may be microfibrillated to obtain microfibrillated cellulose having a modal fibre particle size ranging from about 0.1-500 μm. The fibrous substrate comprising cellulose may be microfibrillated in the presence to obtain microfibrillated cellulose having a modal fibre particle size of at least about 0.5 μm, for example at least about 10 μm, or at least about 50 μm, or at least about 100 μm, or at least about 150 μm, or at least about 200 μm, or at least about 300 μm, or at least about 400 μm.

The fibrous substrate comprising cellulose may be microfibrillated to obtain microfibrillated cellulose having a fibre steepness equal to or greater than about 10, as measured by Malvern. Fibre steepness (i.e., the steepness of the particle size distribution of the fibres) is determined by the following formula:

Steepness=100×(d₃₀/d₇₀)

The microfibrillated cellulose may have a fibre steepness equal to or less than about 100. The microfibrillated cellulose may have a fibre steepness equal to or less than about 75, or equal to or less than about 50, or equal to or less than about 40, or equal to or less than about 30. The microfibrillated cellulose may have a fibre steepness from about 20 to about 50, or from about 25 to about 40, or from about 25 to about 35, or from about 30 to about 40.

1. A mobile facility for producing an inorganic particulate material comprising:
one or more grinders;
a feeder for providing a feed material to the one or more grinders; and
an auxiliary apparatus;
wherein the facility is configured or adapted to produce an inorganic particulate material whereby the particle size of the feed material is reduced by a ratio of at least about 10:1 to produce the inorganic particulate material.

2. The mobile facility of claim 1, wherein the one or more grinders are wet grinders.

3. The mobile facility of claim 1, wherein the one or more grinders are autogenous grinders.

4. The mobile facility of claim 1, wherein the grinders are configured or adapted to process a feed material having a particle size of at least about 1 mm.

5. The mobile facility of claim 1, wherein the inorganic particulate material has a d₅₀ particle size no greater than about 5 μm.

6. The mobile facility of claim 1, wherein the facility is modular.

7. The mobile facility of claim 6, wherein modules are containerized in a plurality of intermodal freight containers.

8. The mobile facility of claim 1, wherein the facility is foundationless.

9. The mobile facility of claim 1 wherein the facility comprises a plurality of grinders.

10. The mobile facility of claim 9, wherein the plurality of grinders are operatively linked in series, or parallel or a combination of series and parallel.

11. The mobile facility of claim 1, wherein the facility is configured or adapted to operate in; (i) an open circuit and (ii) continuous mode.

12. (canceled)

13. The mobile facility of claim 1, comprising at least:
a feed hopper in a first module/container;
a bucket elevator in a second module/container;
a surge hopper, crusher and the feeder for feed material n a third module/container;
the one or more grinders in a fourth module/container;
support structure for the one or more grinders in a fifth module/container;
vibrating screen in a sixth module/container;
centrifuge feed tank in a seventh module/container;
a centrifuge in an eight module/container; and
a storage tank for the inorganic particulate material in a ninth module/container.

14-25. (canceled)

26. A mobile facility for producing an inorganic particulate material comprising:
one or more reactors in a modular container for making an inorganic particulate material;
one or more grinders for grinding starting material fed to the one or more reactors or for grinding the inorganic material produced in the one or more reactors;
a feeder for providing starting material to the one or more reactors or the one or more grinders; and
an auxiliary apparatus.

27. The mobile facility of claim 26, wherein the facility is modular.

28. The mobile facility of claim 27, wherein modules are containerized, for example, in a plurality of intermodal freight containers.

29. The mobile facility of claim 26, wherein the facility is foundationless.

30. The mobile facility of claim 26, wherein the facility comprises a plurality of reactors.

31. The mobile facility of claim 30, wherein the plurality of reactors are operatively linked in series, or parallel, or a combination of series and parallel.

32. The mobile facility of claim 26, wherein the faculty is configured or adapted to operate in: an open circuit and (ii) continuous mode.

33. (canceled)

34. The mobile facility according to claim 1, wherein the mobile facility comprises a plurality stackable and/or modular containers adapted to be housed in or on a truck, a flat bed truck, or another vehicle.

35-36. (canceled)
